(19) United States
(12) Patent Application Publication
(10) Pub. No.: US 2010/0122096 A1
(43) Pub. Date: May 13, 2010

(54) SMPS CIRCUIT WITH MULTIPLE AC/DC INPUTS AND APPLICATION OF SUCH CIRCUIT TO COMPUTER POWER SUPPLIES OR LAPTOP ADAPTERS

(76) Inventor: Sergin Özenc, Izmir (TR)

Correspondence Address: AKERMAN SENTERFITT, P.O. BOX 3188, WEST PALM BEACH, FL, 33402-3188, US

(21) Appl. No.: 12/527,385

(22) PCT Filed: Feb. 15, 2008
(86) PCT No.: PCT/TR2008/000012

§ 371 Date: Aug. 14, 2009

(30) Foreign Application Priority Data
Feb. 15, 2007 (TR) 2007/00878
Feb. 11, 2008 (TR) 2008/00857

(51) Int. Cl. G06F 1/26; H02M 3/335; H02J 1/10

(52) U.S. Cl. 713/300; 307/31; 307/26; 714/14

(57) ABSTRACT

The invention relates to a switch mode power supply (SMPS—Switching Mode Power Supply) which provides the output voltages generated in the AC-network-input switch mode power supply (SMPS—Switching Mode Power Supply) circuits also with battery and similar supply inputs when necessary by using a shared power transformer (T3) having separate power input windings (7, 6) appropriate for the particular input voltage for each input supply and the power switching transistors (Q1, Q2, Q5, Q6) connected to this windings in accordance with the topology used and, which other remaining control, feedback, output rectifying and filtering circuits and other windings of the transformer are single and shared without using a second independent power supply or regulator circuit in addition to the network-input power supply. By the addition of a small dry battery, this concept is applied to the computer power supplies in order to develop an economical Uninterruptible Computer Power Supply (UCPS), which could be installed to the power supply housing in the computer case and which could power the monitor as well. It has also been applied to the laptop computer adaptors and a two-supply-input laptop computer adaptor, which works either from the automobile lighter outlet or from the network with a single adaptor, has been developed.

### TECHNICAL FIELD

This invention relates to the method of adding the battery input to the circuit as a secondary input through a slight modification to the network input circuit instead of using a second switch mode power supply in order to provide the output voltages generated on the switch mode power supply (SMPS) circuits with battery and similar supplies when necessary.

The invention relates particularly to an application of this method to the computer power supplies, which is called as “Uninterruptible Computer Power Supply (UCPS)” and which is installed to the power supply housing in the computer case and which can supply power to the monitor as well, and also the application of this method to the laptop computer adaptors in order to use the car lighter outlet in addition to the electricity network outlet.

### PRIOR ART

There are switch mode power supply circuits (SMPS) converting the AC network voltage into the direct current, low voltage supplies that the electronic circuits could use, in most of the electronic devices used commonly today. A second switch mode power supply circuit that is designed in accordance with the battery voltage input is included in the device in order to enable these devices to work with the batteries in addition to the network voltage. This is generally done in two ways. The first one is to add a switch mode power circuit that directly converts the voltage from the battery into the DC voltages needed by the electronic circuits or the second one is to add an inverter circuit that converts the electricity from the battery into the similar network electricity and provides the network-input-power supply circuit the similar network input it needs. Sometimes, the device is also made to work with the battery by the user via adding an external inverter unit or an Uninterruptible Power Supply.

In the state of the art it is possible to find applications related to this subject. For example the patent application numbered as WO 2005/015721 is related to a converter circuit which has AC and DC supply inputs and a DC output. In WO0176051 USA application related to this subject again a segonder adaptor providing to take DC signal from DC power supply is explained, which has DC signal input terminal and DC signal output terminal.

Since electronic devices at the present day particularly the computers are very sensitive to the electrical interruptions, most of the computers are operated via the external Uninterruptible Power Supplies (UPS) connected serially to the network line. But this also causes an extra cost for users.

In the methods used in present applications a method fitting to each used topology could not be defined to multiply power inputs of switch mode power supplies. In known of the technic some improvements have been carried out for purpose of having a secondary input without using an additional winding but it leads to two disadvantage the first is that the battery voltage which will be used has to be dependent on winding which will be used and the second is that easy switching methods known could not be used for switching the winding.

In conclision precense of necessity of a SMPS circuit with multiple AC/DC inputs which will be optained with lower cost by using an additional winding to the power transformer without needing particularly a second switch mode power supply circuit and precense of necessity of applications of this related method to computer power supplies and laptop computer adaptors forces an improvement in relevant technical area.

### BRIEF DESCRIPTION OF THE INVENTION

The present invention relates to a switch mode power supply circuit with multiple AC/DC inputs which which fulfills a foresaid requirement, eliminates all the disadvantages and provides some additional advantages.

Based on the state of the background art, the object of the invention is to offer an economical and practical solution which dos not require a separate power stage in order that the network powered electronic devices could be powered by battery at the same time.

The object of the invention is provided that it will become a significant alternative to the Uninterruptible Power Supplies for the computers in particular by using computer power supply with battery that provides two inputs in an economical manner with a single power stage.

The object of the invention is provided that a method fitting to each used topology is defined to multiply power inputs in switch mode power supplies.

The object of the invention is provided that the invented method could be applied to all voltage converter switch mode power supplies with transformer. The method includes adding an appropriate extra winding appropriate for this voltage to the transformer for the additional input voltage; adding extra power switching transistors connected appropriately for used topology to the circuit for switching this winding and adding a signal switching circuit that redirects the control signals from the first power switching transistors to the additional power switching transistors when the power will be supplied via the additional input voltage.

In some preferred applications of the invention it is not necessary to redirect the control signals. The power switching transistors belong to whole power inputs can be switched simultaneously by connecting switching signals in parallel with the firs power switching transistors and the other transistors belong to additional power inputs. In this condition only power input stage which power input is applied to will be active even though whole input stages are switched. But in such condition the switching signals have to be connected in the form of that all input wingings will be switched in same phase to avoid that the input windings make short circuit each other by means of magnetic coupling. In a such stracture if the power is applied to more than one input at the same time then the input power stage which division the input voltage value by turns number of the winding connected that input voltage is biggest will be active. Other input power stages do not consume any power from input power.

The method has to be applied to each topology in appropriate form according to transformer stracture and connection style of power switching transistors belong to that topology. If power supply is designed according to a concept other than flyback the winding belong to the additional power input and the power switching transistors connected to this winding have to be combined as any one of full bridge, half bridge or push pull styles except for flyback. For example if the first power input stage is combined as half bridge then the additional power input stage may be combined as any one of full bridge, half bridge or push pull. In such stracture it should not be combined as flyback concept which consists of only one power switching transistor. If the power supply is designed as flyback concept then the additional winding and the power transistor have to be combined as flyback concept. Other connection styles can not be used.

The object of the invention is what it makes possible to operate the computer in a cheap and practical manner by using the same adaptor both from the network and also from the automobile lighter outlet by applying this method to the laptop computer adaptors.

The other object of the invention is to make possible to supply the monitor without need an extra circuit since the first power winding of the power transformer works in the opposite direction and generates a DC high voltage while the battery is active.

The other object of the invention is to provide that the computer is turned off securely before the battery deeply discharged after loading whole main memory to the harddisk by activating hibernate function of the operating system by switching the power button of the computer.

The other object of the invention is to make the battery input active by monitoring the network input voltage by means of a comparator and control circuit and by redirecting the control signals when the network input voltage exceeds the allowed upper and lower limits

To be able to fulfil the advantages mentioned above, the mentioned invention is a switch mode power supply with multiple AC/DC inputs not needing a separate switch mode power supply for each different supply input to convert according to choice from an AC network or battery or different kinds and numbers of supply inputs alternatively to common output voltages and its property is characterized as making desired input active by including at least one winding added to the transformer used in the power supply without changing the existing windings, at least one additional power switching transistor to switch the mentioned winding for each battery or different kind and number input supply voltages and by redirecting the control signals from a control integrated circuit to the power switching transistors of the desired input.

To be able to fulfil the advantages mentioned above the mentioned invention is the method related to adding battery or different kinds and numbers of inputs as the second supply input without adding a second switch mode power supply circuit in switch mode power supplies not using flyback topology and its property is characterized as making desired input active by adding a separate winding appropriate for the mentioned input voltage to a common power transformer for each input, by connected the power switching transistors used for switching the mentioned winding as any one of push pull, full bridge or half bridge technics and by redirecting the control signals from a control integrated circuit to the power switching transistors of the desired input.

To be able to fulfil the advantages mentioned above the mentioned invention is the method related to adding battery or different kinds and numbers of inputs as the second supply input without adding a second switch mode power supply circuit in switch mode power supplies using flyback topology and its property is characterized as making desired input active by adding a separate winding appropriate for the mentioned input voltage to a common power transformer for each input, connecting a power switching transistor used for switching to the mentioned winding according to flyback topology, adding an insulated transformer connected to source pin of the mentioned power switching transistor to generate current sense signal required by control integrated circuit and redirecting the control signals from a mentioned control integrated circuit to the power switching transistor of the desired input.

To be able to fulfil the advantages mentioned above the mentioned invention is the method related to adding battery or different kinds and numbers of inputs as the second supply input without adding a second switch mode power supply circuit in switch mode power supplies using flyback topology particularly in the laptop computer adaptors and its property is characterized as commonly obtaining of the current sense signal required by control integrated circuit for whole inputs by means of a circuit which differentiates in the positive period of the voltage acquired from an auxiliary winding (15), which is wound to the main power transformer and is in the reverse direction compared to the output windings, and zeros the output in the negative period.

By fulfiling the all advantages mentioned above and which will be understood in detailed explanation below the existing invention has many facilities in consideration of its properties mentioned.

The structural and characteristic features and all the advantages of the invention will become clearer from the enclosed drawings and the following detailed description where reference is being made to said drawings, thus the evaluation must be based on these drawings and the detailed description.

### DESCRIPTION OF THE DRAWINGS

In order to best understand the embodiment of the present invention and the advantages thereof together with the supplemental elements, it must be considered along with the drawings for which the description is provided herein below.

FIG. 1 is the circuit diagram that shows the network input filtering and rectifying stage, the primary switching power stage, the control circuit stage and the transformer of the computer power supply. The standby supply circuit, high voltage and over load protection circuits are not shown in the diagram.

FIG. 2 is the circuit diagram that shows the application of the invention method to the circuit depicted in FIG. 1 via symbolic blocks. The standby supply circuit, the high voltage and over load protection circuits and the battery charge circuit are not shown in the diagram.

FIG. 3 is the circuit diagram that shows the application of the invention method to the switch mode power supply that uses the Fly Back topology. In addition, the network monitoring (4) and monitor supply switches (S3, S4) are also added to the diagram in case that it is used as an Uninterruptible Computer Power Supply. The feedback, the standby supply, the control stage supply, the protection and the battery charge circuits are not shown in the diagram.

FIG. 4 is the circuit diagram appropriate for the laptop computer adaptors. In this case, the current sense signals (CS) generated separately for each of the two power input circuits in the application of the invention to the Fly Back topology shown in FIG. 3, are generated simply and jointly by using one differentiating circuit and at the same time the switch redirecting the control signals is canceled.

FIG. 5 is the circuit diagram of the differentiating circuit in FIG. 4.

FIG. 6 is the representation of the input and output voltages in the differentiating circuit on the time axis.

### THE REFERENCE NUMBERS

1) The switch position activating the first supply input of the (S1) and (S2) switches.

2) The switch position activating the second supply input of the (S1) and (S2) switches.

3) 3.3V regulation circuit.

4) A monitoring and comparator circuit that sends a command depending on the result of the comparison the network voltage with a voltage interval between a lower and upper limit.

5) The battery that is the second supply input.

6) The extra winding for the second supply input added to the power transformer (T3) in order to implement the invented method in the switch mode power supplies.

7) The primary winding that belongs to the network input of the power transformer (T3) in the switch mode power supplies.

8) The input windings of the transformer (T2) that drives the first power stage in CPS and UCPS.

9) The input windings of the transformer (T2) that drives the first power stage in CPS and UCPS.

10) The auxiliary winding of the transformer (T2) that drives the first power stage in CPS and UCPS

11) The Monitor supply

12) The AC network supply

13) The output voltage windings used in the fly back topology

14) The output voltage windings used in the fly back topology

15) The auxiliary winding used in order to generate a shared CS signal in the fly back topology.

16) The differentiating circuit

17) The part of circuit that is used in order to zero the output voltage in the differentiating circuit (16).

18) The RC circuit that make approximate differentiating in the differentiating circuit.

19) The representation of the input signal of the differentiating circuit (16) on the voltage-time axis.

20) The representation of the output signal of the differentiating circuit (16) on the voltage-time axis.

21) The “start up” circuit providing the first supply for the controller integrated circuit during a cold start from the battery in the circuit shown in FIG. 4.

22) The control unit which makes short circuit its output line for about 1.5 second when the battery voltage drops under a predefined threshold level while the battery supply is active.

23) The output line of the control unit with two wires connected in parallel to the button front of the computer case.

T, T1) The network input filtering windings.

T2) The transformer driving the power transistors and at the same time insulates the control circuit from the live primary part.

T3) The main power transformer of the power supply circuit.

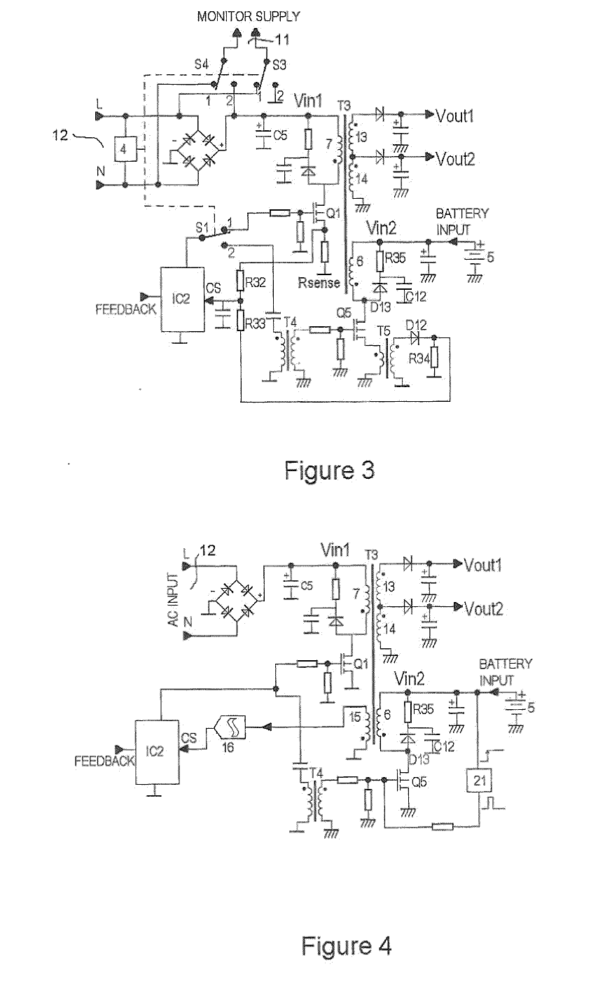

T4) The transformer driving the power transistor (Q5) shown in FIG. 3 and FIG. 4 and that insulates it from the liver part.

T5) The transformer generating the (CS) signal of the second power input stage shown in FIG. 3 and that insulates the second power input from the live part.

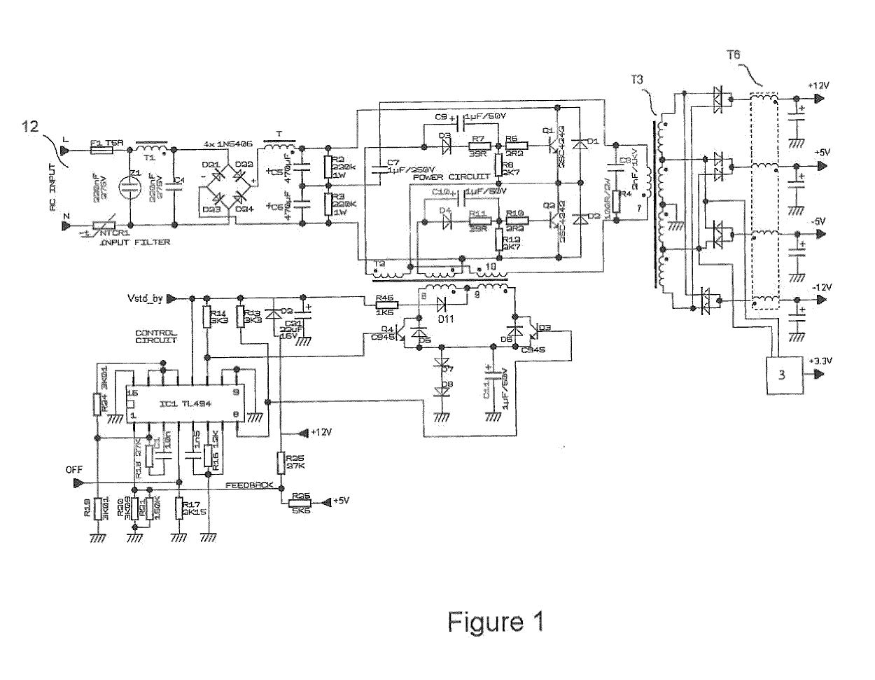

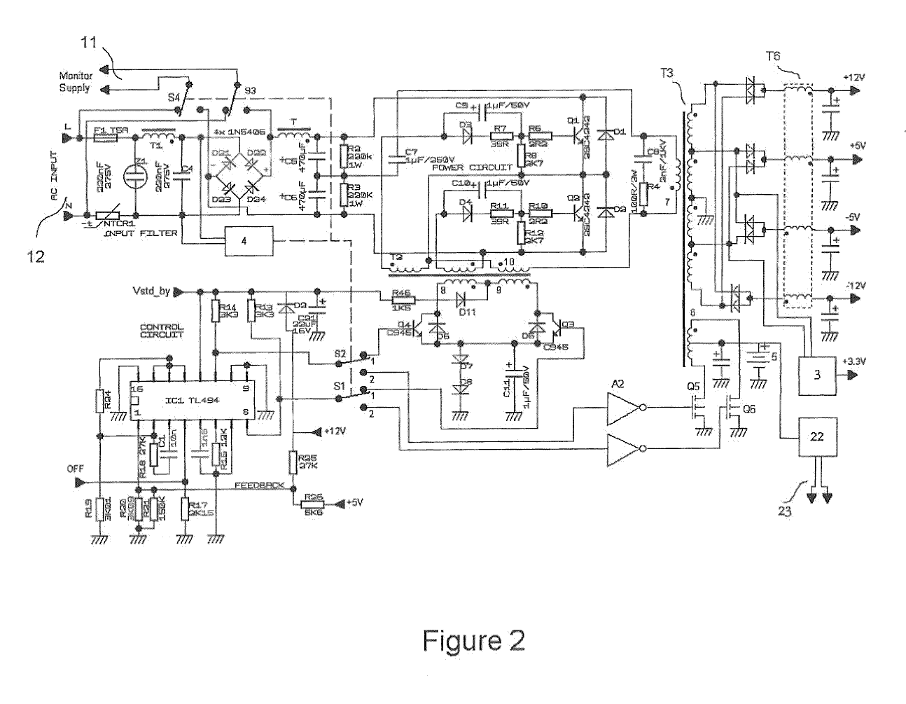

T6) The power distribution coil in FIG. 1 and FIG. 2.

D1, D2, D3, D4, D5, D6, D7, D8, D9, D10, D11, D12, D13, D14, D15, D21, D22, D23, D24) The diodes

C1, C2, C4, C5, C6, C7, C8, C9, C10, C11, C12, C13, C21) The capacitors

R2, R3, R4, R6, R7, R8, R10, R11, R12, R13, R14, R16, R17, R19, R20, Rsense, R32, R33, R34, R35, R36, R37, R46) The resistors.

IC1, IC2) The controller integrated circuits.

A1, A2) The inverter buffer circuits.

Q1, Q2, Q3, Q4, Q5, Q6, Q7, Q8, Q9, Q10, Q11) The transistors.

CS) The Current Sense input of the control integrated circuit.

L) The network live line.

N) The network neutral line.

F1) The fuse.

NTCR1) The Negative Temperature Coefficient Resistor.

Z1) The varistor.

S1, S2) The mechanical or semiconductor selective switches redirecting the control signals that are incoming from the controller circuit and outgoing to the power transistors to the corresponding power transistors of the power input stage that should be active.

S3, S4) The switches separating the supply of the monitor from the main network and connect to the DC supply generated in the case that power goes out in the main network.

### THE DETAILED DESCRIPTION OF THE INVENTION

In this detailed explanation the switch mode power supply with multiple AC/DC inputs which is subject to the invention and the preferred structures of the method related to this and the applications are explained as only an example to be understood more clearly and in a form which has not a limiting effect in the meaning.

In FIG. 1 the circuit diagram that shows the network input filtering and rectifying stage, the primary switching power stage, the control circuit stage and the transformer of the computer power supply used in existing applications is given. The invention method will be explained more clearly and in detail by being applied as in FIG. 2 to the computer power supply circuit shown in FIG. 1. For convenience, we will explain the scenario in which there are only two power inputs: one of them is the network input (12) and the other is the battery (5) input. If desired, the application of the invented method could be repeated in order to reach the desired input number. In this method, an extra winding (6) is added to the transformer (T3) that the power supply uses for the battery (5) input voltage without changing any values of the existing windings. The wire thickness and the number of turns for this additional winding (6) mentioned will be calculated in accordance with the value of the second input (5) voltage and the current that will be taken from the second input. Since in general the first input voltage will be the network voltage (12) and the second will be battery (5), the second input will be generally around 12, 24V—low voltage but high current. Therefore, this extra winding (6) will have less number of turns but a thicker wire than the winding of the first input voltage (7) according to this voltage and current. This extra winding (6) will be activated and switched via the extra switching transistors (Q5 and Q6) added to the circuit. Since the control output signal of the control integrated circuit (IC1) is “open collector” type and it provides the control output signal with pull up resistors (R13, R14), the output impedance is high at the high state of the signal. Furthermore, the transistors (Q1, Q2) are turned on in low state rather than the high state. Small buffer circuits (A1, A2), which reduces the output impedance and inverts the signals, are added in order to provide the same driving form for the second supply input stage too. These buffer circuits (A1, A2) are not necessary for the circuits that can provide low-impedance output at each state of the signal and make transistors (Q1, Q2) conducted in high state of the control signal. The second power switching transistor group (Q5, Q6) is connected in push pull manner since it could be applied simpler to the circuit in this application. But if desired, it could be also connected as full bridge or half bridge. However, in that case it wouldn't be possible to drive the transistors (Q5, Q6) directly as in FIG. 2 and a drive circuit that uses a signal transformer as T2 or some other methods according to these topologies should be set. While the S1 and S2 switches in FIG. 2 are in “1” position, the control signals incoming from the control integrated circuit (IC1) drive the power switching transistors (Q1 and Q2) that belong to the first input supply. The S1 and S2 switches should come to the position “2” when it is necessary to cancel the first supply (12) input and make the second supply (5) input to power the circuit. In this case, the second supply input (5) will become active since the control signals generated by the control integrated circuit will go to the second power switching stage. The S1 and S2 switches are added symbolically in order to explain the invented method simply and clearly. The function of these switches (S1, S2) could be performed simply by semiconductor components and even by small power transistors.

The application shown in FIG. 2 is a part of an Uninterruptible Computer Power Supply (UCPS) circuit, which automatically makes the network electricity (12) input passive when the network electricity is interrupted or the voltage goes out of the specific upper and lower bounds considered risky and activates the second power input—the battery (5) input—and ensures continuity of the output voltages (+12V, +5V, +3.3V, −5V, −12V) that power the computer in this way and also automatically switches (S3 and S4) the monitor supply to power the monitor with a direct current too. The other property of the invention is also that provides to turn off the computer securely after saving whole dates in main memory to its harddisk by making short circuit its output line (23) connected in parallel to the computer power button when the voltage drops under a predefined threshould level because of discharge. Some circuit stages are not included in the diagram, since they are not related directly or indirectly to the application of the invention; by any means, they will remain same in the Uninterruptible Computer Power Supply (UCPS) as they are in the computer power supply. Therefore, they are not shown in the diagram. Furthermore the circuit charging the battery (5) by using an output voltage of the power supply by limiting the charge current and voltage. A comparator circuit (4), which continuously monitors the first input voltage and gives an output when it is not between a lower and upper bound, sends the required command to the position changing switches (S1, S2, S3, S4). The direct current monitor supply (11) is obtained since the first power stage works in the opposite direction and generates a DC high voltage while the second power stage is active. In other words, no extra component or extra transformer windings are necessary to obtain the monitor supply (11). As it was stated before, when the extra winding (6) that is added for the second input is powered, alternative output voltages that is proportional to the number of turns are generated at all the other windings and therefore an alternative voltage is also generated at the primary winding (7) where the first power goes in. This generated voltage is rectified via the diodes (D1) and (D2), regulated via capacitors (C5) and (C6) and filtered via the coil (T3) and then sent to the monitor through the switches (S3) and (S4). The (S3) and (S4) switching can be performed via a relay since a delay of 5-10 ms wouldn't be so critical. In this condition while AC network supply is available the monitor will be supplied by AC network supply directly, while AC network supply is not available it will be supplied by DC supply generated by means of that the main power transformer (T3) works in reverse direction. If the monitor without cathode ray tube (CRT) will be used, (S3) and (S4) switches are not necessary. It is not disadvantageous to supply the monitor continuously from DC supply because if the monitor is without CRT the degause function which can be supplied only by AC network electricity will not be exist within monitor. In this condition by canceling this relay the monitor supply can be provided directly from the cathodes of the diodes (D22) and (D24) and the anodes of the diodes (D21) and (D23).

Another important point that should be taken care of during the design of the circuit is the possibility of the alternative voltage, which will be generated at the extra winding (6) proportionately with the number of turns, to cause a problem while the first power stage is active. In the case that the peak value of the voltage generated at the middle end of the winding (6) exceeds the battery (5) voltage as much as diode forward voltage, reverse diodes in the switching power transistors (Q5 and Q6) will start to conduct and cause negative currents in a direction that will charge the battery (5). In other words, this power stage will be able to work in reverse direction too. But this charging current is a current with no control or restriction. This current would get exceedingly high depending on the level of the first input voltage and consequently damage the battery (5) if it exceeds maximum charging current of the battery or damage the circuit if it exceeds maximum allowable current. It isn't also very reasonable to insert some components such as the diodes in order to prevent the circuit to work in the reverse direction. Because, the components inserted will become very hot and the voltages on them will not be kept small and therefore, it will cause a serious voltage and efficiency loss since it is a circuit working with high currents while the second power circuit is active. In this case, the most reasonable solution is to keep the number of turns of the second power winding (6) low in a manner that the peak output value of the second power winding (6) doesn't exceed the battery voltage even at the highest limit voltage allowed by the comparator circuit (4) for the first input voltage.

While the battery supply is active the function of the control unit (22) in FIG. 2 is to prevent the computer from turning off itself suddenly and improperly because of overdischarge of the battery. To fulfil this function this control unit (22) continuously monitors the battery voltage and when the voltage drops under a predefined threshould level it makes short circuit its output line (23) which has two wires for about 1.5 second. The output line (23) of the mentioned control unit (22) is connected in parallel to power button in front of the computer case by means of a couple of wires. To perform the function of the circuit (22) the option of the “hibernate” when the power button pressed should be selected from the power options in control panel in the Windows Operating System. When the battery voltage drops under a predefined threshould level the computer turns off itself securely after saving whole datas in main memory to its harddisk by performing the Hibernate function of the Windows Operating System. When the computer turns on after the network electricity (12) becomes normal it is ensured that the computer starts from the last point before turning off by loading back the datas to main memory as consequence of the Hibernate function.

In conclusion, by using the invented method, an Uninterruptible Computer Power Supply (UCPS) can be manufactured with a minimal extra cost added to the cost of a normal computer power supply, which makes the battery (5) online when the network electricity (12) is out or when the voltage is not between the lower and upper limits and power the computer along with its monitor and serves both as a computer power supply and also an Uninterruptible Power Supply (UPS) by being used in the computer case instead of using a normal computer power supply, and its battery and circuits of which is assembled in a metal box that fits the power supply housing of the computer case or its battery of which is connected externally inside or outside the computer case and charges its battery by using one of the output voltages in a controlled manner.

In FIG. 3 the circuit diagram that shows the application of the invention method to the switch mode power supply that uses the Fly Back topology is given. In addition, the network monitoring (4) and the monitor supply switches (S3, S4) are also added to the diagram in case that it is used as an Uninterruptible Computer Power Supply. The feedback, the standby supply, the control stage supply, the protection and the battery charge circuits are not shown in the diagram. In FIG. 4 the circuit diagram appropriate for the laptop computer adaptors is given. In this case, the current sense signals (CS) generated separately for each of the two power input circuits in the application of the invention to the Fly Back topology shown in FIG. 3, are generated simply and jointly by using one differentiating circuit and at the same time the switch redirecting the control signals is canceled.

In order to make possible the application of the invented method to the laptop computer adaptors, it is necessary to realize an application that is in compliance with the switch mode power supplies, which use the fly back topology, because the laptop computer adaptors are generally manufactured by using the fly back topology. Moreover, the fly back topology is also used in some desktop computer power supplies. This topology is also used in the televisions and lots of electronic devices. FIG. 3 and FIG. 4 illustrate how the invented method could be implemented for the fly back topology. Vcc supply circuit, oscillator circuit, feedback circuit, stand by supply circuit, charge circuit and primary start up circuit are not shown in the figures in order to give the diagram as simple as possible and to focus on the application of the method. However, these shared circuits should be present for both the single-input supply and also for the multi-input supply that the method is applied to during the application. The application is basically the same. But the transistor (Q5) in the second power switching circuit should be connected in accordance with the topology. An extra winding (6) that is in the same direction with the primary (7) is added to the power transformer (T3) here too. This winding (6) is switched and energized via a power switching transistor (Q5) that is connected in compliance with the fly back topology. Since the “current sense” (CS) signal is necessary along with the feedback in order to make the required control in the fly back topology, a small signal transformer (T5) is added at the source of the transistor (Q5) to generate the “current sense” signal, as shown in FIG. 3. While this function is performed via a simple resistor (Rsense) for the switching power circuit of the first power input, a transformer (T5) was used for the second power stage. Because it is hard to insert a resistor since the current in the second power stage is too high and also it is objected to provide the required insulation from the hazardous primary part in accordance with the safety rules. While the primary of the transformer (T5) mentioned has few windings (one or two) but is thick wired, the secondary has more windings and is thin wired since it is the signal output. The CS signals incoming from each of the two power stages are combined through the 1K resistors (R32, R33) and transmitted to the controller integrated circuit (IC2). The point which should be noted hereby is that the two CS signals reduce the outputs level nearly to an half level by loading one another since they are connected to each other. Therefore, each of the two outputs levels should be redoubled in comparison to the case where they are singly connected. The second power transistor is driven by a driver transformer (T4) in a manner that preserves the insulation in order to provide the required electrical insulation between the primary part, which is the live part, and the secondary part which includes the parts that the user can access, in compliance with the international safety rules. It is possible to toggle between the two input supplies (5, 12) via a switch (S1). The switch (S1) only changes the power input stage that receives the control signals. The input supply, which the position of the switch (S1) redirects the control signals to, is activated and the other one remains passive. It is also possible to perform this switching via the semiconductor components. When the circuit is used as an Uninterruptible Computer Power Supply, a comparison and decision circuit (4) that sends a control signal to the switches (S1, S3, S4) by tracing the network voltage and the relay switches (S3, S4), which will redirect the high voltage DC that is generated by the network power input and switching stage (7, C5, Q1) by working in reverse direction while the battery power input is active, to the monitor are added to the circuit shown in FIG. 3.

The application would be made cheaper and simpler by connecting the power switching control signals of the network (12) and battery (5) supplies in parallel to each other as shown in FIG. 4, instead of putting a position selector switch (S1), since the network and the battery supply will not be provided simultaneously when the invented method is applied to the laptop computer adaptors. In this case, both of the power switching stages will be switched together, but only the power stage that receives the supply will be active. The transistor (Q1 or Q5) of the other power stage will not have any function even if it is switched, since it will not have any supply. Performing a cold start from the battery would be necessary for the application of the invented method to the laptop computer adaptors. Therefore, the supply (Vcc) of the control integrated circuit should be provided first in order to have the circuit start working at the moment the battery is connected to the circuit. In order to realize this, a simple circuit (21) generating a transient single pulse at the moment the battery supply arrives, is added to the gate input of the second power input switching transistor (Q5) as shown in FIG. 4. The transistor (Q5) will keep on conductive during this pulse and the network primary winding (7) will work in reverse direction and charge (C5) condenser in this period. After this condenser is charged, the control integrated circuit (IC2) will act as if the network electricity is on and will start the network “start up” circuit, which is not shown in the diagram, in order to provide the first supply (Vcc) voltage. After the operation with the first supply is ensured, the circuit will be able to generate its own supply (Vcc) anyway.

In order to make simpler and cheaper the application of the invention to the fly back topology, a common CS signal could be obtained by transmitting a signal voltage acquired from a small auxiliary winding (15) added to the power transformer (T3) through an approximate differentiating circuit (16), instead of generating separate CS signals for each power input stage and then combining them as shown in FIG. 4. If we should explain the method of generating a common CS signal via differentiating circuit (16) mentioned with formulas (valid as long as the power transistors are on):

Vcs=lin×Rsense, (F1)

Since V=L×dl/dt (F2),

I=1/L×∫V.dt in coils; (F3)

lin=1/Lpirimer∫Vin1.dt (F4)

Vcs=(Rsense/Lpirimer)×∫Vin1.dt (F5)

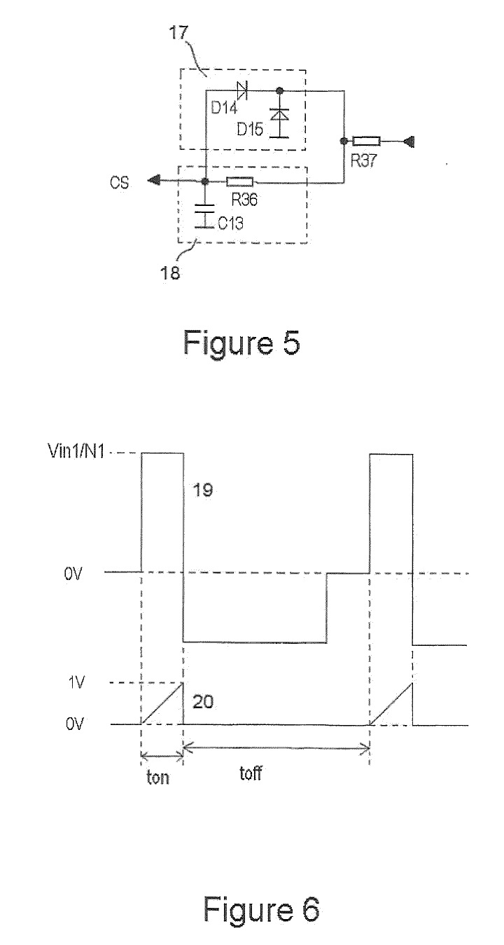

As it can be seen, the CS signal is in fact just the differentiation of Vin1 voltage multiplied with the (Rsense/Lprimary) constant. And if Vin1 is assumed to be constant during the period, then this is a slope function which its gradient is (Rsense×Vin1/Lprimary). Therefore, the signal obtained from the output of a circuit (16), which differentiates the voltage taken over an auxiliary winding (15) which has N1 times less number of turns, representing the Vin1 voltage on the network primary winding (7) and then multiplies this differentiation with the constant N1×(Rsense/Lprimary), will have the same value as the CS signal expressed in formula (F5). The number of turns ratios of windings should be set in order to obtain approximately the same voltage from the auxiliary winding (15) in the case that the second power input stage is active. So the auxiliary winding (15) and the differentiating circuit (16) can be shared by both of the power input stages. Instead of establishing a complex differentiating circuit for the differentiating process, a simple RC circuit (18) shown in FIG. 5 can provide an approximate differentiation. Since the maximum value of the CS signal is limited by 1V and since the Vin1/N1 output voltage of the auxiliary winding (15) will be a lot greater than 1V, the voltage on C13 will exhibit the characteristic of almost a constant slope over the 0-1V range. The CS signal should be zero according to the first formula (F1), since the primary current (lin) will be zero in the period where the power transistor is off. This is realized via the circuit (17) that consists of the diodes D14 and D15 shown in FIG. 5. Since the auxiliary winding (15) output voltage will be negative in the period where the power transistor is off, the capacitor C13 will be quickly discharged over the diodes (D14, D15) and its capacity is kept around zero volt throughout the period. The resistor R37 is placed in order to restrict the over-current on the diodes and to prevent the auxiliary winding to overcharge during this negative period; and its resistance value is much smaller compared to that of the resistor R36. The input signal (19) and the output signal (20) of the differentiating circuit (16) is shown on the voltage-time coordinate in FIG. 6, ignoring the oscillations that occur at the power switching moments.

The circuit diagram of the application of the invention to the laptop computer adaptors with “fly back” topology is shown in FIG. 4. An extra socket is placed in the adaptor box for the battery input. When the adaptor will be used in an automobile, the cable connection, whose one end goes to the socket on the adaptor the other end goes to the automobile lighter outlet, should be utilized. When it will be operated using the network, a connection cable, whose one end is inserted to the network connector on the adaptor and the other end is inserted to the wall plug just like the other adaptors, will be installed. in conclusion, the user won't have to carry an extra adaptor in order to use the laptop computer in the automobile without time restriction; just an extra cable for the lighter outlet connection will suffice. And the cost of this application will also be a lot cheaper than total price of two separate adaptors.

The protective scope of the present application is determined in the part of claims, and the scope may by no means be limited to the description above provided only by way of example. It is obvious that a person skilled in the art may also provide the innovative step of the invention using the similar embodiments and/or apply this embodiment to other fields with similar purpose used in the relevant art. Consequently, such embodiments would obviously lack the criteria of innovative step and particularly, exceeding the known state of the art.

1. A switch mode power supply with multiple AC/DC inputs not needing a separate switch mode power supply for each different supply input to convert according to choice from an AC network or battery or different kinds and numbers of supply inputs alternatively to common output voltages, the switch mode power supply comprising at least one winding added to the transformer (T3) used in the power supply without changing the existing windings; and
at least one additional power switching transistor (Q5, Q6) to switch the said winding for each battery or different kind and number input supply voltages and conducting the control signals from a control integrated circuit (IC1) to the input power switching transistors (Q1, Q2, Q5, Q6).

2. The switch mode power supply with multiple AC/DC inputs according to claim 1, further comprising at least one signal switching circuit that redirects the control signals from the first power switching transistors to the additional power switching transistors when the power will be supplied via the additional input voltage.

3. The switch mode power supply with multiple AC/DC inputs according to claim 1, further comprising inverting buffer circuits (A1, A2) which its one end is connected to (S1) and (S2) switches its other end is connected to the gate pin of the power switching transistors said and inverting the signals degreasing output empedance.

4. The switch mode power supply with multiple AC/DC inputs according to claim 1, further comprising an uninterruptible computer power supply (UCPS) which brings the battery online when the electricity is out or when the voltage is not between the lower and upper limits and powers the computer along with its monitor and serves both as a computer power supply and also an Uninterruptible Power Supply (UPS) by being used in the computer case instead of using a normal computer power supply, and its battery and circuits of which is assembled in a metal box that fits the power supply housing of the computer case or its battery of which is connected externally inside or outside the computer case and charges its battery by using one of the output voltages in a controlled manner.

5. The switch mode power supply with multiple AC/DC inputs according to claim 4, wherein the additional winding for the battery input has fewer turns but a thicker wire than the winding of the first input voltage.

6. The switch mode power supply with multiple AC/DC inputs according to claim 4, further comprising at least one control circuit which automatically makes the network electricity input passive when the network electricity is interrupted or the voltage goes out of specified upper and lower bounds and activates the battery input and ensures continuity of the output voltages (+12V, +5V, +3.3V, −5V, −12V) that power the computer in this way.

7. The switch mode power supply with multiple AC/DC inputs claim 6, wherein the number of turns of the second power winding is kept low in a manner that the peak output value of the second power winding does not exceed the battery voltage even at the highest limit voltage allowed by the comparator circuit for the first input voltage.

8. The switch mode power supply with multiple AC/DC inputs according to claim 4, wherein the extra winding which is added for the second input is powered when the battery is active, alternative output voltages that is proportional to the number of turns are generated at all the other windings and therefore an alternative voltage is also generated at the primary winding where the first power goes in and this generated voltage at the primary winding is rectified via the diodes (D1) and (D2), regulated via capacitors (C5) and (C6) and filtered via the coil (T3) in other word the power stage where the network input goes in works in opposite direction and so by not needing any additional circuit supplies the monitor through the switches (S3) and (S4).

9. The switch mode power supply with multiple AC/DC inputs according to claim 7 wherein the monitor supply can be provided directly from the cathodes of the diodes (D22) and (D24) and the anodes of the diodes (D21) and (D23) by not needing (S3) and (S4) redirection switches if monitor without cathode ray tube (CRT) is used.

10. The switch mode power supply with multiple AC/DC inputs according to claim 1, wherein it comprises at least one control unit which continuously monitors the battery voltage and when the voltage drops under a predefined threshould level because of discharge, turns off the computer securely after saving whole datas in main memory to its hard disk by shorting its output line connected in parallel to the computer power button via a pair of wires for a fixed time and thereby starting a hibernate function of the operating system.

11. A method related to adding battery or different kinds and numbers of inputs as the second supply input without adding a second switch mode power supply circuit in switch mode power supplies not using flyback topology characterized by:
providing a separate winding appropriate for the said input voltage to a common power transformer (T3) for each input;
connecting the power switching transistors (Q5, Q6) used for switching the said winding as any one of push pull, full bridge or half bridge technics; and
conducting the control signals from a control integrated circuit (IC1) to the input power switching transistors (Q1, Q2, Q5, Q6).

12. The method according to claim 11 characterized in that redirecting the control signals from the first power switching transistors (Q1, Q2) to the additional power switching transistors (Q5, Q6) via the redirecting switches (S1, S2) when supplying by the additional voltage is desired.

13. The method according to claim 11, wherein the control signals are connected in parallel to the transistors (Q1, Q2, Q5, Q6) without needing any redirecting switches (S1, S2) in a manner that the all power input windings will work together and in same phase, and wherein the input power stage which the division the values of the input voltages by turns number of the winding connected that input voltage is biggest will be active and that other input power stages do not consume any power from the input power.

14. A method related to adding battery or different kinds and numbers of inputs as the second supply input without adding a second switch mode power supply circuit in switch mode power supplies using flyback topology comprising the steps of:
adding a separate winding appropriate for the said input voltage to a common power transformer (T3) for each input, connecting a power switching transistor (Q5) used for switching to the said winding according to flyback topology;
adding an insulated transformer (T5) connected to source pin of the said power switching transistor (Q5) to generate current sense (CS) signal required by control integrated circuit (IC2); and
conducting the control signals from the said control integrated circuit (IC2) to the input power switching transistors (Q1, Q5).

15. The method according to claim 14, further comprising redirecting the control signals from a said control integrated circuit (IC2) to the power switching transistor (Q1 or Q5) selected via at least one redirection switch.

16. A method according to claim 14, wherein while the primary of the transformer (T5) has few windings but is thick wired, the secondary has more windings and is thin wired since it is the signal output.

17. The method according to claim 14, wherein the said power transistor (Q5) is driven by at least a driver transformer (T4) in a manner that preserves the insulation in order to provide the required electrical insulation between the primary part, which is the live part, and the secondary part which includes the parts that the user can access.

18. A method related to adding battery or different kinds and numbers of inputs as the second supply input without adding a second switch mode power supply circuit in switch mode power supplies using flyback topology particularly in the laptop computer adaptors comprising the steps of
commonly obtaining the current sense signal (CS) required by control integrated circuit (IC2) for whole inputs by means of a circuit which differentiates in the positive period of the voltage acquired from an auxiliary winding, which is wound to the main power transformer (T3) and is in the reverse direction compared to the output windings, and zeros the output in the negative period.

19. The method according to claim 14, wherein connecting the power switching control signals of the network and battery supplies in parallel to each other, and both of the power switching stages are switched together, but only the power stage that receives the supply is active.

20. The method according to claim 18, wherein the supply (Vcc) which should be given to the control integrated circuit (IC2) is provided by a simple circuit generating a transient single pulse to the gate input of the second power transistor (Q5) at the first moment the battery is connected to the circuit to be able to start working of the power supply circuit.

21. The method according to claim 18, wherein a simple RC circuit provides an approximate differentiation instead of establishing a complex differentiating circuit for the differentiating process.

22. The switch mode power supply with multiple AC/DC inputs according to claim 1, the comprising a two-supply-input laptop computer adaptor by putting a battery input connector additional to the network input on the adaptor case, which can work either from the automobile battery by plugging a lighter cable to the battery input connector if desired or from the network by plugging the network cable to the network input if desired with a single adaptor.
